(19) United States
(12) Patent Application Publication
(10) Pub. No.: US 2018/0304672 A1
(43) Pub. Date: Oct. 25, 2018

(54) Method and apparatus for combining two writing instruments together to create lines of arbitrary equidistant width

(71) Applicant: Richard Thomas Mueller, Minneapolis, MN (US)

(72) Inventor: Richard Thomas Mueller, Minneapolis, MN (US)

(21) Appl. No.: 15/495,938

(22) Filed: Apr. 24, 2017

(51) Int. Cl. B43K 23/06

(52) U.S. Cl. CPC B43K 23/06

(57) ABSTRACT

The invention holds two writing or drawing instruments such as pencils between two plates for the purpose of drawing two adjustable equidistant lines an arbitrary distance apart for use in calligraphy or drawing. It allows the pencils to rotate around a common point and in a common plane so that it may be adjusted that the two tips can touch and thus create smaller parallel lines for creating smaller calligraphic characters than previously possible.

### BACKGROUND OF THE INVENTION

Creating calligraphic letters using two writing instruments is nothing new, but this is the first invention that allows for line distances smaller than half the diameters of both barrels of the writing instruments. Such small distances are necessary to create smaller calligraphic letters.

Prior art includes fixing two pencils together with rubber bands, but this method cannot produce lines of an adjustable width. Other prior art includes fixing two pencils together and rotating about a common point (like a compass) so their tips are relative to each other, however, none of the prior art holds the pencils both in a common plane relative to one another while rotating about a common point such that their tips can completely touch.

### BRIEF SUMMARY OF THE INVENTION

The invention holds two writing or drawing instruments such as pencils between two plates for the purpose of drawing two adjustable equidistant lines an arbitrary distance apart for use in calligraphy or drawing. It allows the pencils to rotate around a common point and in a common plane so that it may be adjusted that the two tips can touch and thus create smaller parallel lines for creating smaller calligraphic characters than previously possible.

### BRIEF DESCRIPTION OF THE DRAWINGS

FIG. 1 shows the completed assembly holding any two writing instruments such as pencils.

FIG. 2 shows an exploded view of the device.

FIG. 3 shows a side view of the device.

FIG. 4 shows a top view, featuring the top part of thumb nut 1 and plate 2.

FIG. 5 shows a three-quarters view of the device.

FIG. 6 shows the bottom view, featuring plate 5 and the screw end of thumb nut 1.

FIG. 7 shows the device with a cross-section of the two writing instruments (the circular dashed lines).

FIG. 8 shows the device with the two writing instruments configured to have their tips together.

FIG. 9 shows the device configured with the tips of the two writing instruments set wider apart.

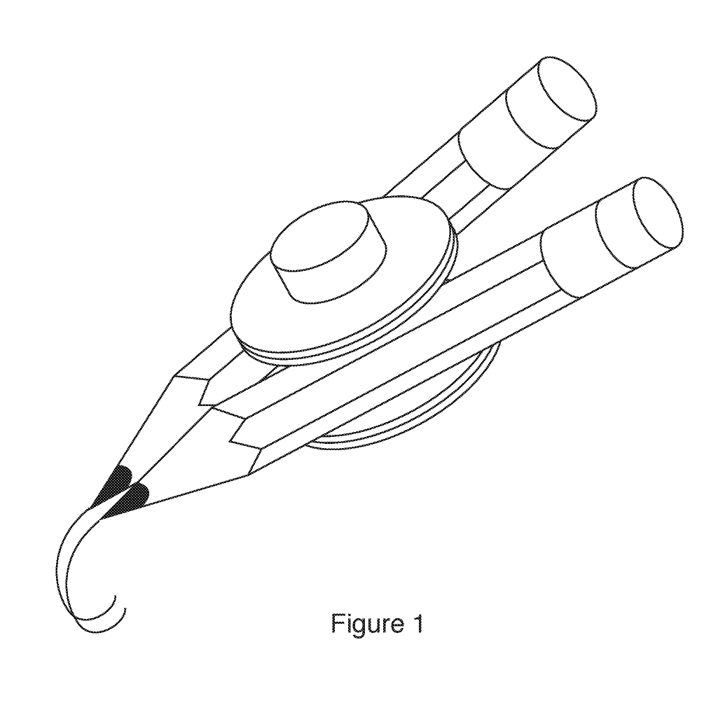

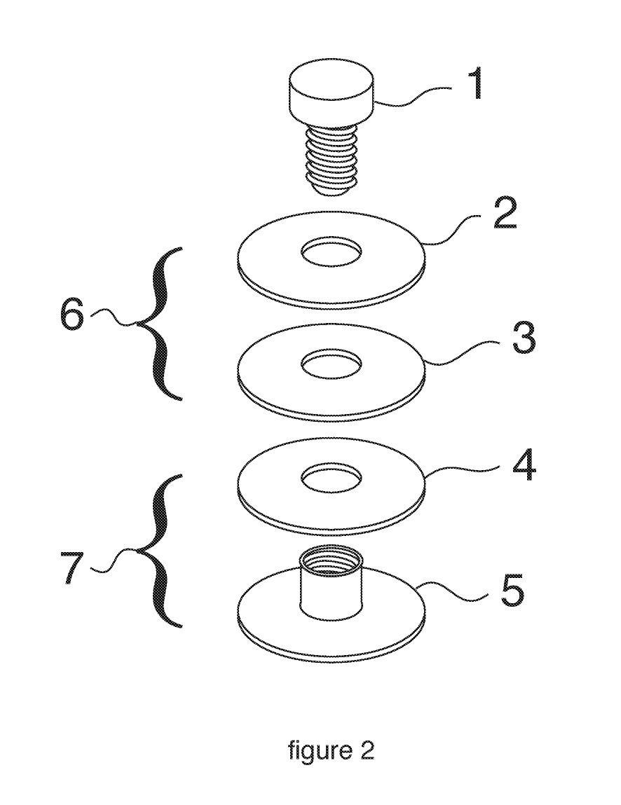

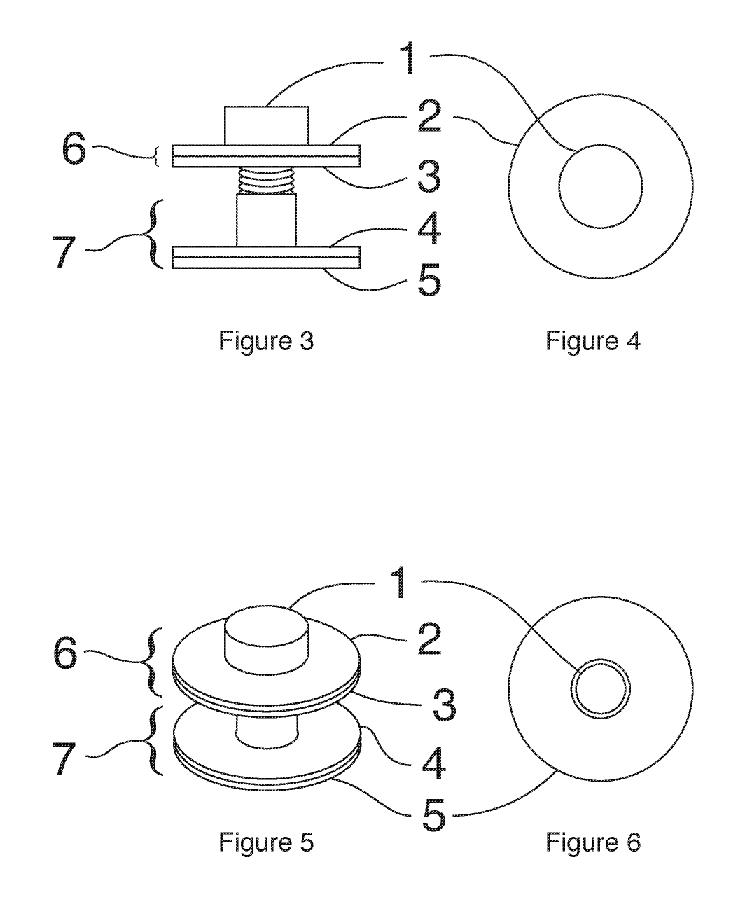

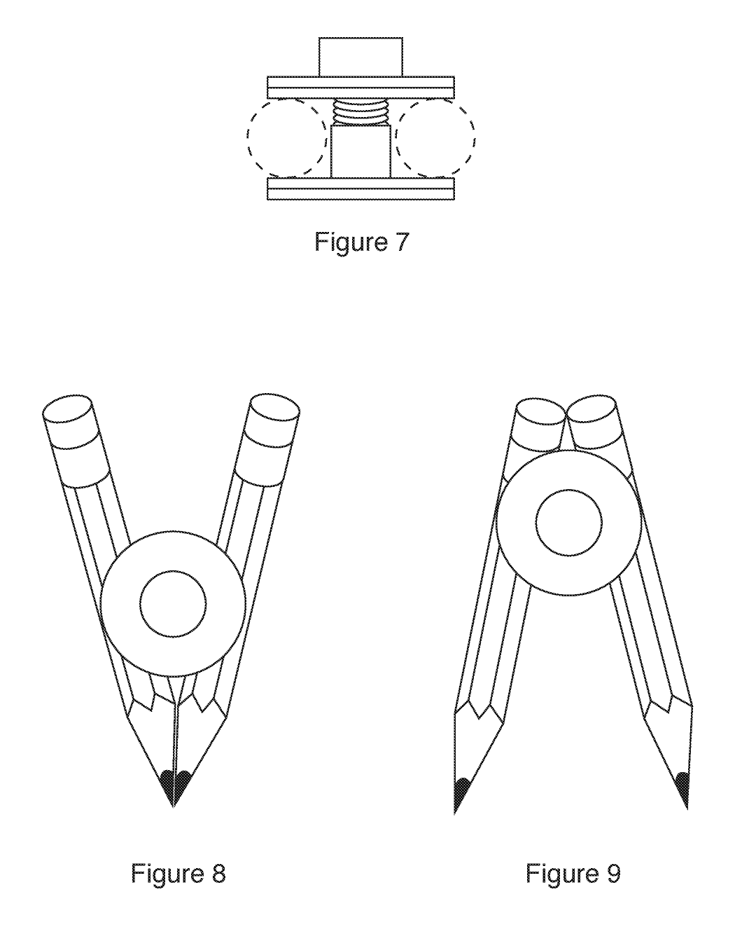

In FIGS. 2, 3 and 5: plate 2 has padding 3 glued or otherwise fixed on its lower surface (collectively, top plate 6); plate 5 has padding 4 glued or otherwise fixed to its upper surface, around its threaded collar (collectively, bottom plate 7); top plate 6 and bottom plate 7 are connected by a thumb nut that passes through top plate 6 and threads into the threaded collar of bottom plate 7.

Plate 2 and plate 5 may be made of metal, wood, plastic, or any sufficiently sturdy material to clamp the pencils in place; in the preferred embodiment plate 2 may be a fender washer and plate 5 may be a weld nut; the padding 3 and padding 4) are neoprene washers that are glued, epoxied, or otherwise bonded to the facing surfaces of plate 2 and plate 5. Thumb nut 1 may be made of metal, wood, plastic, or any sufficiently sturdy material to hold the top plate 6 and bottom plate 7 together firmly enough to hold the writing or drawing instruments in place between them.

Another embodiment may include a cam lever in place of the thumb nut, such that operating the cam lever pushes the top plate toward the bottom plate, compressing the pencils between the plates.

Another embodiment may include one or more tension springs on the outside of the plates that compress the top and bottom plates together rather than screwing them together.

Another embodiment may include a scissors clamp such as a clothes pin compressing the top and bottom plates together.

### DETAILED DESCRIPTION OF THE INVENTION

The invention generally relates to the field of calligraphy and lettering or design in general. The invention allows a method of quickly and easily drawing equidistant lines of adjustable width for drawing calligraphic letters, creating consistent guidelines for layout, and to allow beginners to practice calligraphy using cheaper materials than calligraphic pens, ink and paper. This solution is unique in that it rotates two writing instruments around a common pivot and in a common plane, allowing their tips to be positioned any width apart or so the tips are touching, which obtains much smaller line widths and thus makes possible smaller calligraphic characters.

This invention is quick and easy to adjust, comfortable to hold, and grips the writing utensils without slippage. With this invention any two writing instruments of approximately equal diameter may be used, for example wooden or mechanical pencils, pens, chalk, crayons, markers, or even combinations thereof. This invention allows for creating lines of virtually any arbitrary width while being easily adjustable and easy to hold.

This invention allows the lettering scripts of virtually any width and height, while at the same time easily creating straight or curved equidistant guidelines. It allows students to practice letter forms in various sizes without wasting expensive ink and paper. It also allows the calligrapher to draw both the top and bottom guidelines for the letters in a single pass, either as straight parallel lines or as curved equidistant lines, which simplifies the layout and design process greatly and further increases this invention's utility. This invention may also be used to draw circular lines like a compass.

1. A writing or drawing instrument holder comprising:
a flat top plate and a bottom plate parallel to one another and holding between them two writing instruments oriented in a common plane together;
and

2. The invention of claim 1 further comprising: padding of a material such as neoprene, leather, or felt, affixed to the facing surfaces of said top plate and said bottom plate to cushion and grip the contact of barrels of said writing instruments between said top plate and said bottom plate.

3. The invention of claim 1 further comprising: a decorative end cap covering the bottom of said bottom plate.

4. The invention of claim 1 further comprising: a threaded thumb nut passing through said top plate and threading into said bottom plate such that tightening the nut compresses the writing instruments between said plates.
